(19) United States
(12) Patent Application Publication
(10) Pub. No.: US 2010/0055554 A1
(43) Pub. Date: Mar. 4, 2010

(54) POSITIVE ELECTRODE ACTIVE MATERIAL POWDER AND POSITIVE ELECTRODE ACTIVE MATERIAL

(75) Inventors: Masami Makidera, Ibaraki (JP); Akiyoshi Nemoto, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Chuo-ku, Tokyo (JP)

(21) Appl. No.: 12/515,022

(22) PCT Filed: Nov. 20, 2007
(86) PCT No.: PCT/JP2007/072882

§ 371 Date: May 15, 2009

(30) Foreign Application Priority Data
Nov. 21, 2006 (JP) 2006-313887

(51) Int. Cl. H01M 4/58; H01M 4/88; H01M 2/16

(52) U.S. Cl. 429/144; 429/231.95; 252/182.1

(57) ABSTRACT

The present invention provides a powder for a positive electrode active material containing particles containing two or more elements selected from transition metal elements and in the cumulative particle size distribution on the basis of volume of the particles composing the powder, the particle diameter (D50) observed from the finer particle side at 50% accumulation is in the range of 0.1 μm or larger and 10 μm or smaller, and 95% by volume or more of the particles composing the powder exit in the range of 0.3 time or more and 3 times or less as large as D50.

### TECHNICAL FIELD

The present invention relates to a powder of positive electrode active material and positive electrode active material.

### BACKGROUND ART

A powder for a positive electrode active material is used as a raw material for a positive electrode active material. Further, a positive electrode active material is used as a positive electrode for a nonaqueous electrolyte secondary battery such as a lithium secondary battery. A nonaqueous electrolyte secondary battery is used as an electric power source for mobile phones, notebook personal computers, and the like, and is tried for uses for middle and large scale applications such as automobile applications and power storage applications. With respect to the secondary battery, it is required to increase the capacity and a positive electrode active material suitable for packing densely in a positive electrode.

As conventional powders for a positive electrode active material, Japanese Patent Application Laid-Open (JP-A) No. 2006-151795 discloses a nickel hydroxide powder of spherical particles having an average particle diameter of 0.1 μm or larger and 30 μm or smaller and particle size distribution that 80% by weight or more particles exist in the range of 0.7 to 1.3 times as large as the average particle diameter.

### DISCLOSURE OF THE INVENTION

However, to obtain a positive electrode active material for a nonaqueous electrolyte secondary battery with a high capacity by using a conventional powder for a positive electrode active material, the powder, a lithium salt, and a manganese salt are mixed and calcined to obtain a positive electrode active material; however, the cohesive force of primary particles composing the active material is probably too strong to break into particles easily, and from the viewpoint of dense filling of the positive electrode, the material is insufficient. The purpose of the present invention is to obtain a positive electrode active material which can be packed more densely and which is suitable for obtaining a high capacity nonaqueous electrolyte secondary battery when used for the positive electrode of the nonaqueous electrolyte secondary battery, and a powder for a positive electrode active material as a raw material.

In view of the above circumstances, the inventors of the present invention has made various investigations and finally completed the present invention.

That is, the present invention provides the following inventions.

<1> A powder for a positive electrode active material containing particles containing two or more elements selected from transition metal elements, wherein, in the cumulative particle size distribution on the basis of volume of the particles composing the powder, a particle diameter (D50) observed from the finer particle side at 50% accumulation is in the range of 0.1 μm or larger and 10 μm or smaller, and 95% by volume or more of the particles composing the powder exit in the range of 0.3 time or more and 3 times or less as large as D50.
<2> A powder for a positive electrode active material containing particles containing two or more elements selected from transition metal elements, wherein, 95% by volume or more of the particles composing the powder exit in the range of 0.6 μm or larger and 6 μm or smaller.
<3> The powder for a positive electrode active material according to <1> or <2> containing at least Ni as a transition metal element.
<4> The powder for a positive electrode active material according any one of <1> to <3> containing two or more element selected from Ni, Mn, Co and Fe as a transition metal element.
<5> The powder for a positive electrode active material according any one of <1> to <4>, wherein the constituent particles composing the powder for a positive electrode active material are approximately spherical particles.
<6> The powder for a positive electrode active material according one of <1> to <5>, wherein a content of Na in the powder for a positive electrode active material is 1% by weight or less.
<7> A powder-form positive electrode active material obtained by calcining a mixture obtained by mixing the powder for a positive electrode active material according to any one of <1> to <6> and a lithium compound.
<8> The positive electrode active material according to <7>, wherein, in the cumulative particle size distribution on the basis of volume of the particles composing the positive electrode active material, the particle diameter (D50) observed from the finer particle side at 50% accumulation is in the range of 0.1 μm or larger and 10 μm or smaller, and 95% by volume or more of the particles composing the positive electrode active material exit in the range of 0.3 times or more and 3 times or less as large as D50.
<9> A positive electrode active material according to <7>, wherein the 95% by volume or more of the particles composing the positive electrode active material exist in the range of 0.6 μm or larger and 6 μm or smaller.
<10> A method for producing the powder for a positive electrode active material including the following steps (1), (2), and (3) carried out in this order:

(1) a step of producing an emulsion by passing a water phase containing two or more elements selected from transition metal elements through fine pores with an average fine pore diameter of 0.1 to 15 μm and bringing the water phase into contact with an oil phase:

(2) a step of producing gel by bringing the emulsion into contact with a water-soluble gelling agent: and

(3) a step of separating the gel into a cake and a liquid and drying the cake to obtain a powder for a positive electrode active material,

<11> A method for producing a positive electrode active material by mixing the powder for a positive electrode active material according to any one of <1> to <6> or the powder for a positive electrode active material obtained by the production method according to <10> with a lithium compound, and calcining the obtained mixture at a temperature of 600° C. or higher and 1100° C. or lower.
<12> A positive electrode for a nonaqueous electrolyte secondary battery containing the positive electrode active material according to any one of <7> to <9>.
<13> A nonaqueous electrolyte secondary battery containing the positive electrode for a nonaqueous electrolyte secondary battery according to <12>.
<14> The nonaqueous electrolyte secondary battery according to <13> further containing a separator.
<15> The nonaqueous electrolyte secondary battery according to <14>, wherein the separator comprises a laminated porous film formed by laminating a heat resistant layer containing a heat resistant resin and a shutting down layer containing a thermoplastic resin.

When the positive electrode active material obtained by using the powder for a positive electrode active material of the present invention is used for a positive electrode of a nonaqueous electrolyte secondary battery, it is made possible to pack the material more densely and to obtain a nonaqueous electrolyte secondary battery with a high capacity and thus the present invention is industrially remarkably advantageous.

### BRIEF DESCRIPTIONS OF THE DRAWINGS

FIG. 1 is a SEM photograph of the powder 1 for a positive electrode active material of Example 1 and showing particles composing the powder.

FIG. 2 is a view showing the measurement result of the particle size distribution of the powder 1 for a positive electrode active material of Example 1.

FIG. 3 is a SEM photograph of the powdery positive electrode active material 1 of Example 1 and showing particles composing the active material.

FIG. 4 is a view showing the measurement result of the particle size distribution of the positive electrode active material 1 of Example 1.

FIG. 5 is a SEM photograph of the positive electrode active material 3 of Comparative Example 1 and showing particles composing the powder.

FIG. 6 is a view showing the measurement result of the particle size distribution of the positive electrode active material 3 of Comparative Example 1.

FIG. 7 is a schematic view showing an embodiment of emulsion production in the method for producing a powder for a positive electrode active material of the present invention.

FIG. 8 is a drawing showing a discharging curve of a lithium secondary battery of Example 2.

FIG. 9 is a view showing a discharging curve of a lithium secondary battery of Example 4.

### BEST MODE FOR CARRYING OUT THE INVENTION

The present invention provides a powder for a positive electrode active material comprising particles containing two or more elements selected from transition metal elements, wherein, in the cumulative particle size distribution on the basis of volume of the particles composing the powder, the particle diameter (D50) observed from the finer particle side at 50% accumulation is in the range of 0.1 μm or larger and 10 μm or smaller, and 95% by volume or more of the particles composing the powder exit in the range of 0.3 time or more and 3 times or less as large as D50. Herein, that D50 is in the range of 0.1 μm or larger and 10 μm or smaller, and that 95% by volume or more of the particles composing the powder exit in the range of 0.3 time or more and 3 times or less as large as D50 can be investigated by measuring the particle size distribution of the powder by a laser diffraction scattering method. In terms of preferable application of the present invention, D50 is preferably in the range of 0.6 μm or larger and 6 μm or smaller and more preferably in the range of 1 μm or larger and 3 μm or smaller.

The present invention provides a powder for a positive electrode active material made of particles containing two or more elements of transition metal elements, wherein 95% by volume or more of the particles composing the powder exit in the range of 0.6 μm or larger and 6 μm or smaller. Herein, that 95% by volume or more of the particles composing the powder exit in the range of 0.6 μm or larger and 6 μm or smaller can be investigated by measuring the particle size distribution of the powder by laser diffraction scattering method. In terms of preferable application of the present invention, it is preferable that 95% by volume or more of the particles composing the powder exist preferably in the range of 1 μm or larger and 3 μm or smaller.

In the present invention, examples of the transition metal elements may include Ni, Mn, Co, and Fe, and in terms of preferable use as the positive electrode active material, the powder for a positive electrode active material of the present invention is preferable to contain at least Ni. Further, to obtain a nonaqueous electrolyte secondary battery with a higher capacity, the powder for a positive electrode active material is preferable to contain two or more elements selected from Ni, Mn and Co as transition metal elements. In the present invention, in the case where Ni is contained as a transition metal element, in terms of increase of a capacity of the nonaqueous electrolyte secondary battery, a molar ratio of Ni and transition metal elements other than Ni (one or more elements selected from Mn, Co, and Fe) is preferably in the range of 0.05:0.95 to 0.95:0.05 and more preferably in the range of 0.3:0.7 to 0.7:0.3.

In terms of dense packing of the positive electrode active material in a positive electrode, with respect of the powder for a positive electrode active material of the present invention, the particle composing the powder are preferable to be approximately spherical particles.

The powder for the positive electrode active material of the present invention can be produced as follows. That is, the powder is produced by the steps (1), (2), and (3) carried out in this order:

(1) a step of producing an emulsion by passing a water phase containing two or more elements selected from transition metal elements through fine pores with an average fine pore diameter of 0.1 to 15 μm and bringing the water phase into contact with an oil phase;

(2) a step of producing gel by bringing the emulsion into contact with a water-soluble gelling agent; and

(3) a step of separating the gel into a cake and a liquid and drying the cake to obtain a powder for a positive electrode active material.

In the step (1), the water phase containing two or more elements selected from transition metal elements can be obtained by dissolving, as transition metal compounds, chlorides, nitrates, acetates, formats, and oxalates of these elements. Among the compounds, acetates are preferable. In the case where compounds such as oxides hard to be dissolved in water are used as the transition metal compounds, the compounds may be dissolved in an acid such as hydrochloric acid, sulfuric acid, nitric acid or the like to give the water phase. In the case where two or more elements selected from transition metal elements are Ni and Mn, Ni acetate and Mn acetate are preferable to be used in combination as the transition metal compounds. Further, a surfactant may be added to the water phase. As the surfactant, specific examples include polycarboxylic acids, their ammonium salts, polyacrylic acids, or their ammonium salts.

In the step (1), the fine pores may have an average fine pore diameter of 0.1 to 15 μm and the fine pores may be nozzles having fine pores and fine pores of porous membranes and porous material. D50 of the powder for a positive electrode active material to be obtained may be changed by changing the average fine pore diameter of the fine pores to be used. In the case where fine pores of porous material is used as fine pores, the porous material may be those having relatively uniform fine pore diameter and practical examples are sirasu porous glass (hereinafter, referred to as SPG), porous glass, porous ceramic and the like and the SPG is preferable since the fine pore diameter can accurately be adjusted. The surface of the porous material is preferable to be made oleophilic. For example, in the case of SPG, the surface of porous material is hydrophilic and in the case where oleophilicity is required, surface treatment may be carried out by a method of, for example, immersing the porous material in a silicon resin solution and drying the porous material; applying a silane coupling agent to the porous material, and bringing the porous material into contact with trimethylchlorosilane.

In the step (1), a nonaqueous organic solvent may be used as the oil phase. Specific examples include toluene, cyclohexane, kerosene, hexane, benzene, or the like. In the case where acetic acid is contained in the water phase, cyclohexane is preferable to be used. A surfactant may be added to the oil phase. Specific examples of the surfactant include sorbitan esters, glycerin esters, and the like.

Using the above-mentioned water phase, fine pores, and oil phase, the water phase is passed and brought into contact with the oil phase to produce an emulsion. In this case, the water phase, fine pores, and oil phase may be arranged in the order of water phase/fine pores/oil layer (/ means the interfaces of the respective components) and pressure is applied to the water phase, so that the water phase is brought into contact with the oil phase after passing the fine pores to produce the emulsion. When the water phase is parted from the fine pores after passing the fine pores, the water it is preferable to add operation of quickly separating the water phase from the fine pores and practically, it is preferable to carry out operation of vibrating the porous material or circulating the oil phase. The emulsion obtained in such a manner contains fine droplets of an aqueous solution of two or more metal ions selected from transition metal elements.

In the step (2), the above-mentioned emulsion and a water-soluble galling agent are brought into contact with each other to produce gel. In the present invention, the gel is a slurry-form substance. As the water-soluble gelling agent, ammonium chloride, ammonium hydrogen carbonate, sodium hydroxide, sodium carbonate, lithium hydroxide, and the like can be employed. An example of a method for bringing the emulsion and a water-soluble gelling agent into contact with each other includes a method of adding an aqueous solution of a water-soluble gelling agent to the emulsion. Further, an emulsion-form gelling agent obtained by dispersing a water-insoluble organic solvent described above in an aqueous solution of a water-soluble gelling agent is previously produced and it may be added to the emulsion. Use of the emulsion-form gelling agent makes the powder for a positive electrode active material to be obtained finally composed of particles with more even particle diameters. The emulsion-form gelling agent can be produced by employing a method of producing fine droplets, for example, a membrane emulsification method and methods of using an apparatus such an ultrasonic homogenizer, an agitation type homogenizer, or the like.

Further, in the step (1), the gelation of the emulsion can be carried out by employing the above-mentioned emulsion-form gelling agent as an oil phase.

An amount (mole) of the water-soluble gelling agent to be used is generally set to be 1.0 time or more and 10 times or less as much as the amount (mole) of the transition metal elements to be used in the step (1).

In the step (3), the above-mentioned gel is separated into a cake and a liquid and the cake is dried to obtain a powder for a positive electrode active material. The separation can be carried out by solid-liquid separation operation such as filtration, decantation, or the like industrially employed in general. Further, drying can be carried out by methods of hot air drying and fluidized bed drying to an extent that the particles of the powder for a positive electrode active material are not broken. Furthermore, the cake before drying may be washed with water or the like.

The present invention provides a powdery positive electrode active material obtained by calcining a mixture obtained by mixing the above-mentioned powder for a positive electrode active material and a lithium compound. The shapes of the particles composing the positive electrode active material are derived from particles composing the powder for a positive electrode active material.

With respect to the positive electrode active material of the present invention, in the cumulative particle size distribution on the basis of volume of particles composing the positive electrode active material, the particle diameter (D50) observed from the finer particle side at 50% accumulation is preferably in the range of 0.1 μm or larger and 10 μm or smaller and 95% by volume or more of the particles composing the positive electrode active material exit preferably in the range of 0.3 time or more and 3 times or less as large as D50. Furthermore, 95% by volume or more of the particles composing the positive electrode active material preferably exit in the range of 0.6 μm or larger and 6 μm or smaller. Further, in the case of using the positive electrode active material for a nonaqueous electrolyte secondary battery, in order to more increase the capacity of the battery, a content of Na in the powder for a positive electrode active material is preferably 1% by weight or lower and more preferably 0.8% by weight or lower.

The positive electrode active material of the present invention can be produced by calcining a mixture obtained by mixing the above-mentioned powder for a positive electrode active material and a lithium compound at a temperature of 600° C. or higher and 1100° C. or lower. At the time of mixing, the ratio of the amount (mole) of the transition metals and the lithium amount (mole) of the lithium compound in the powder for a positive electrode active material may be adjusted to be 1:0.8 to 1:1.7 and preferably 1:0.9 to 1:1.4.

Examples of the above-mentioned lithium compound may be carbonates, hydroxide, nitrates, chlorides, sulfates, hydrogen carbonates, and oxalates and carbonates are preferably used.

The mixing may be carried out by dry mixing industrially employed in common. Examples of dry mixing apparatus include a V shaped mixers, a W cone shaped mixers, a ribbon shaped screw mixers, a drum mixer, and a dry type ball mill.

It is possible to produce the positive electrode active material of the present invention by adding a lithium compound to the above-mentioned cake, drying and calcining the cake. In this case, the lithium compound is preferably a water-soluble compound such as lithium hydroxide, lithium nitrate, and lithium chloride. Examples of a method of adding a lithium compound in the cake include a method of immersing the cake in an aqueous solution of a lithium compound, a method of adding a lithium compound in the water phase and/or the oil phase, and a method of adding a lithium compound in the oil phase.

The calcining may be carried out at a temperature of 600° C. or higher and 1100° C. or lower. The calcining time is generally 2 to 30 hours. At the time of calcining, the temperature may be increased from room temperature to the above-mentioned temperature at a speed to an extent that a calcining container containing the mixture is not broken, for example, 100° C./hour to 500° C./hour. The ambient atmosphere for the calcining may be selected properly from air, oxygen, nitrogen, argon, or their gas mixture in accordance with the composition of the positive electrode active material to be obtained and it is generally oxygen-containing atmosphere. The atmosphere easy to be handled is air.

With respect to the positive electrode active material to be obtained after calcining, based on the necessity, the material may be pulverized using a pulverizer such as a vibration mill, a jet mill, a dry type ball mill, or classification operation such as air blow classification may be carried out. At that time, it is required to handle the positive electrode active material carefully to avoid breakage of the particles of the material. Further, coating treatment of the positive electrode active material may be carried out. More specifically, surfaces of the particles composing the positive electrode active material may be coated by depositing a compound containing an element selected from B, Al, Mg, Co, Cr, Mn, Fe, and the like. In such a manner, coating treatment for the positive electrode active material sometimes more improves the safety of the nonaqueous electrolyte secondary battery to be obtained.

For example, using above-mentioned positive electrode active material, a positive electrode can be obtained as follows. A positive electrode can be produced by depositing a positive mixture containing the positive electrode active material, a conductive material, and a binder in a positive electrode current collector. Examples of the conductive material include carbonaceous materials such as natural graphite, artificial graphite, coke, and carbon black. Examples of the above-mentioned binder include thermoplastic resins and specifically, fluoro-resins such as poly(vinylidene fluoride) (hereinafter, sometimes referred to as PVDF), polytetrafluoroethylene, tetrafluoroethylene-hexafluoropropylene-vinylidene fluoride copolymers, hexafluoropropylene-vinylidene fluoride copolymers, and tetrafluoroethylene-perfluorovinyl ether copolymers; and polyolefin resins such as polyethylene and polypropylene. As the above-mentioned positive electrode current collector, Al, Ni, and a stainless steel may be used. Examples of a method for depositing the positive mixture to the positive electrode current collector include a method of pressure molding and a method involving obtaining a paste using an organic solvent, applying the paste to the positive electrode current collector, and firmly depositing it by pressing after drying. In the case of forming a paste, a slurry containing the positive electrode active material, a conductive material, a binder, and an organic solvent is produced. Examples of the organic solvent include amines such as N,N-dimethylaminopropylamine and diethyltriamine; ethers such as ethylene oxide and tetrahydrofuran; ketones such as methyl ethyl ketone; esters such as methyl acetate; non-protonic polar solvents such as dimethylacetamide and 1-methyl-2-pyrrolidone. Examples of a method for applying the positive mixture to the positive electrode current collector include a slit die coating method, a screen coating method, a curtain coating method, a knife coating method, a gravure coating method, an electrostatic spray method, and the like.

A nonaqueous electrolyte secondary battery containing the positive electrode active material of the present invention may be produced, for example, as follows. That is, an electrode unit obtained by laminating or rolling the above-mentioned positive electrode, a separator, and a negative electrode obtained by depositing a negative mixture in a negative electrode current collector is housed in a battery can and then impregnated with an electrolyte solution made of an organic solvent containing an electrolyte.

The shape of the above-mentioned electrode unit may be, for example, a shape giving circle, ellipse, rectangle, and a rectangular shape with rounded corners as a cross-sectional view in the vertical direction to the rolling axis of the electrode unit. Further, the shape of the battery may be, for example, a paper type, a coin type, a cylindrical type, and a square type.

Examples usable as the above-mentioned negative electrode may be those obtained by depositing negative mixture containing a material capable of intercalating and deintercalating lithium ion in a negative electrode current collector, lithium metal, or a lithium alloy, and specific examples of the material capable of intercalating and deintercalating lithium ion include carbonaceous materials such as natural graphite, artificial graphite, coke, carbon black, thermally decomposed carbons, carbon fibers, organic polymer compound-calcined bodies and also usable are chalcogen compound such as oxides, sulfides, and the like which can carry out intercalation and deintercalation of lithium ion at a lower potential than that of the positive electrode. The shape of the carbonaceous material may be any one, for example, a flaky shape such as natural graphite, a spherical shape such as mesocarbon microbeads, a fibrous shape such as graphitized carbon fibers, or an agglomerate of fine powders.

The above-mentioned negative mixture may contain a binder, according to necessity. Examples of the binder include thermoplastic resins, and specific examples include PVDF, thermoplastic polyimides, carboxymethyl cellulose, polyethylene, polypropylene, and the like.

The above-mentioned positive electrode current collector may be Cu, Ni, and stainless steel and Cu is preferable because being hard to form an alloy with lithium and being easy to be processed to a thin film. A method for depositing the negative mixture in the negative electrode current collector is the same as that of the positive electrode, and examples may be a method of pressure molding and a method involving obtaining a paste using an organic solvent, applying the paste to the negative electrode current collector, and firmly depositing it by pressing after drying.

As the above-mentioned separator, for example, materials in a form of a porous membrane, a nonwoven fabric, and a woven fabric made of materials such as polyolefin resin such as polyethylene and polypropylene, fluoro-resins, and nitrogen-containing aromatic polymers can be used, and a single-layer or laminated separators using two or more kinds of these materials may be used. Examples of the separator are separators described in JP-A Nos. 2000-30686 and 10-324758. The thickness of the separator is more preferable as it is thinner since the volume energy density of the battery is increased and the inner resistance is lowered and it is preferably about 5 to 200 μm and more preferably about 5 to 40 μm.

In the nonaqueous electrolyte secondary battery, generally, it is important to shut electric current and inhibit excess current flow at the time abnormal electric current flows in the battery (shut down) because of short-circuiting between the positive electrode and negative electrode. Accordingly, the separator is required to carry out the shutting down at a temperature as low as possible (close the fine pores of a porous film), keep the shutting down state without being broken at the temperature even if the temperature of the battery is increased to a certain temperature after the shutting down; in other words, the separator is required to have high heat resistance. Use of a separator of a laminated porous film obtained by laminating a heat resistant layer containing a heat resistant resin and a shutting down layer containing a thermoplastic resin as the separator more prevents thermal breakage of the film of the secondary battery of the present invention.

Hereinafter, a separator of a laminated porous film obtained by laminating a heat resistant layer containing a heat resistant resin and a shutting down layer containing a thermoplastic resin will be described. Herein, the thickness of the separator is generally 40 μm or thinner and preferably 20 μm or thinner. Further, in the case where the thickness of the heat resistant layer is defined as A (μm) and the thickness of the shutting down layer is defined as B (μm), it is preferable that the A/B value is 0.1 or higher and 1 or lower. Further, the separator has air permeability of preferably 50 to 300 second/100 cc and more preferably 50 to 200 second/100 cc on the basis of air permeability by Gurley method from the viewpoint of ion permeability. The porosity of the separator is generally 30 to 80% by volume and preferably 40 to 70% by volume.

In the laminated porous film, the heat resistant layer contains a heat resistant resin. To further improve the ion permeability, the thickness of the heat resistant layer is 1 μm or thicker and 10 μm or thinner, preferably 1 μm or thicker and 5 μm or thinner, and particularly preferably 1 μm or thicker and 4 μm or thinner. Furthermore, the heat resistant layer has fine pores and the size (diameter) of the pores is generally 3 μm or smaller and preferably 1 μm or smaller. The heat resistant layer can contain filler described later.

The heat resistant resin contained in the heat resistant layer may be polyamides, polyimides, polyamide-imides, polycarbonates, polyacetals, polysulfones, polyphenyl sulfides, polyether ether ketones, aromatic polyesters, polyether sulfones, and polyether imides, and from the viewpoint of further improvement of heat resistance, polyamides, polyimides, polyamide-imides, polyether sulfones, and polyether imides are more preferable and polyamides, polyimides, and polyamide-imides are even more preferable. Furthermore preferably, the heat resistant resins are nitrogen-containing aromatic polymers such as aromatic polyamides (para-oriented aromatic polyamides, meta-oriented aromatic polyamides), aromatic polyimides, aromatic polyamide-imides and particularly preferably aromatic polyamides and in terms of the production, even more preferably para-oriented aromatic polyamides (hereinafter, sometimes referred to as “para-amides”). Examples of the heat resistant resin may also include poly-4-methylpent-1-ene and cyclic olefin polymers. Use of these heat resistant resins can improve the heat resistance, that is, the thermal membrane breakage temperature can be increased.

The thermal membrane breakage temperature depends on the type of a heat resistant resin and the thermal membrane breakage temperature is generally 160° C. or higher. Use of the above-mentioned nitrogen-containing aromatic polymers as the heat resistant resin can increase the thermal membrane breakage temperature to about 400° C. at maximum. Further, in the case of using poly-4-methylpent-1-ene and in the case of using a cyclic olefin type polymer, the thermal membrane breakage temperature is increased to about 250° C. at maximum and about 300° C. at maximum, respectively.

The above-mentioned para-amides are obtained by condensation polymerization of para-oriented aromatic diamines and para-oriented aromatic dicarboxylic acid halides and substantially those containing repeating units bonded at the orientation positions of para- or corresponding orientation positions (e.g., orientation positions in the same axes or parallel in the opposed directions such as 4,4′-biphenylene, 1,5-napthalene, and 2,6-naphthalene) for amide bonds of aromatic rings. The para-amides may be para-oriented structure type para-amides or para-amides with structure equivalent to the para-oriented type, and specific examples include poly(p-phenyleneterephalamide), poly(p-benzamide), poly(4,4′-benzanilidoterephthalamide), poly(p-phenylene-4,4′-biphenylenedicarboxylic acid amide), poly(p-phenylene-2,6-naphthalenedicarboxylic acid amide), poly(2-chloro-p-phenyleneterephthalamide), p-phenyleneterephthalamide-2,6-dichloro-p-phenyleneterephthalamide copolymer.

The above-mentioned aromatic polyimides are preferably entirely aromatic polyimides produced by condensation polymerization of aromatic diacid anhydrides and diamides. Specific examples of the diacid anhydrides include pyromellitic acid anhydride, 3,3′,4,4′-diphenylsulfonetetracarboxylic acid anhydride, 3,3′,4,4′-benzophenonetetracarboxylic acid anhydride, 2,2′-bis(3,4-dicarboxyphenyl)hexafluoropropane, and 3,3′,4,4′-biphenyltetracarboxylic acid anhydride. Examples of the diamines include oxydianiline, p-phenylenediamine, benzophenonediamine, 3,3′-methylenedianiline, 3,3′-diaminobenzophenone, 3,3′-diaminodiphenylsulfone, and 1,5′-naphthalenediamine. Further, polyimides soluble in solvents can be also preferably used. Examples of such polyimides include polyimides as condensation polymers of 3,3′,4,4′-diphenylsulfonetetracarboxylic acid dianhydride and aromatic diamines.

Examples of the above-mentioned aromatic polyamide imides are those obtained by condensation polymerization of aromatic dicarboxylic acids and aromatic diisocyanates and those obtained by condensation polymerization of aromatic dicarboxylic acid anhydrides and aromatic diisocyanates. Specific examples of the aromatic dicarboxylic acids include isophthalic acid and terephthalic acid. Practical examples of the aromatic dicarboxylic acid anhydrides include trimellitic anhydride. Specific examples of the aromatic diisocyanates include 4,4′-diphenylmethane diisocyanates, 2,4-tolylene diisocyanates, 2,6-tolylene diisocyanates, o-tolylene diisocyanates, and m-xylene diisocyanates.

The filler which may be added to the heat resistant layer may be any selected from organic powers, inorganic powders, and their mixtures. The particles composing the filler are preferable to have an average particle diameter of 0.01 μm or lager and 1 μm or smaller. With respect to the shape of the filler, approximately spherical, plate-form, column-form, needle-form, whisker-form and fibrous shapes may be exemplified and any particles may be used and since easy to form uniform pores, approximately spherical particles are preferable.

Examples of the organic powders as the filler include powders of organic materials such as homo- or copolymers of two or more of styrene, vinyl ketone, acrylonitrile, methyl methacrylate, ethyl methacrylate, glycidyl methacrylate, glycidyl acrylate, and methyl acrylate; fluoro-resins such as polytetrafluoroethylene, tetrafluoroethylene hexafluoropropylene copolymers, tetrafluoroethylene-ethylene copolymers, and polyvinylidene fluorides; melamine resins; urea resins; polyolefins; and polymethacrylates. The organic powders may be used alone or two or more of them may be used in mixing. Among these organic powders, from the viewpoint of chemical stability, polytetrafluoroethylene powder is preferable.

The inorganic powders as the filler may include, for example, powders of inorganic materials such as metal oxides, metal nitrides, metal carbonates, metal hydroxides, carbonates, sulfates, and the like, and specific examples include powders of alumina, silica, titanium dioxide, and calcium carbonate. The inorganic powders may be used alone or two or more of them may be used in mixing. Among these inorganic powders, from the viewpoint of chemical stability, alumina powder is preferable. It is preferable that all of the particles composing the filler are alumina particles and it is more preferable that all of the particles composing the filler are alumina particles, and at the same time, a part or all of the particles are approximately spherical alumina particles.

Although it depends on the specific gravity of the material of the filler, the content of the filler in the heat resistant layer is generally 20 or more and 95 or less and preferably 30 or more and 90 or less in the case where the total weight of the heat resistant layer is set to be 100 if all particles composing the filler are alumina particles. These ranges can be set properly depending on the specific gravity of the material of the filler.

In the laminated porous film, the shutting down layer contains a thermoplastic resin. The thickness of the shutting down layer is generally 3 to 30 μm and more preferably 3 to 20 μm. The shutting down layer, similarly to the above-mentioned heat resistant layer, has fine pores and the size of the pores is generally 3 μm or smaller and preferably 1 μm or smaller. The porosity of the shutting down layer is generally 30 to 80% by volume, and preferably 40 to 70% by volume. In the nonaqueous electrolyte secondary battery, if it exceeds a normal use temperature, the shutting down layer has a function of closing the fine pores by softening the thermoplastic resin composing the layer.

As the thermoplastic resin contained in the shutting down layer, thermoplastic resins that are soften at 80 to 180° C. can be exemplified, and those not dissolving in the electrolyte solution of the nonaqueous electrolyte secondary battery may be selected. Specifically, polyolefins such as polyethylene and polypropylene and thermoplastic polyurethanes can be exemplified and two or more of these compounds may be used in form of mixtures. To soften at a lower temperature and shut down, polyethylene is preferable as the thermoplastic resin. Specifically preferable as the polyethylene are polyethylenes such as low density polyethylene, high density polyethylene and linear polyethylene as well as very high molecular weight polyethylene. To further increase the penetration strength of the shutting down layer, the thermoplastic resin is preferable to contain at least very high molecular weight polyethylene. In view of production of the shutting down layer, the thermoplastic resin is sometimes preferable to contain a wax of a low molecular weight (weight average molecular weight of 10,000 or lower) of a polyolefin.

With respect to the above-mentioned electrolyte solution, examples to be used as the electrolyte include LiClO₄, LiPF₆, LiAsF₆, LiSbF₆, LiBF₄, LiCF₃SO₃, LiN(SO₂CF₃)₂, LiC(SO₂CF₃)₃, Li₂B₁₀Cl₁₀, lower fatty acid lithium salts, and LiAlCl₄ and a mixture of two or more of them may also be used. Among them, at least one compound selected from a group containing fluorine containing compounds LiPF₆, LiAsF₆, LiSbF₆, LiBF₄, LiCF₃SO₂, LiN(SO₂CF₃)₂, and LiC(SO₂CF₃)₃ is preferable to be used.

In the above-mentioned electrolyte solution, examples as the organic solvent include carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethyoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters of methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propanesultone; and those obtained by introducing fluoro-substituent groups into the above-mentioned organic solvents and generally two or more of them may be used in mixing.

In place of the above-mentioned electrolyte solution, a solid electrolyte may be used. As the solid electrolyte, for example, polymer electrolytes such as polyethylene oxide type polymer compound and polymer compounds containing at least one of polyorganosiloxane chains and polyoxyalkylene chains can be used. Further, so-called gel type obtained by supporting nonaqueous electrolyte solution in a polymer can also be usable. Furthermore, if an organic compound electrolyte, e.g. sulfide electrolytes such as Li₂S—SiS₂, Li₂S—GeS₂, Li₂S—P₂S₅, and Li₂S—B₂S₃; and sulfides such as Li₂S—SiS₂—Li₃PO₄, and Li₂S—SiS₂—Li₂SO₄ is used, the safety may sometimes be improved more. Further, in the nonaqueous electrolyte secondary battery of the present invention, in the case of using a solid electrolyte, the solid electrolyte sometimes works as a separator, and in such a case, a separator is sometimes unnecessary.

Hereinafter, the present invention will be described more in detail with reference to Examples. With respect to powders, the particle shape, particle diameter (D50), and the particle size distribution were evaluated by the following methods.

### 1. Particle Shape

The shape of the particles composing a powder was evaluated by SEM observation of the particles composing the powder using SEM (scanning electronic microscope, JSM-5500 model, manufactured by JEOL).

### 2. Particle Diameter (D50) and the Particle Size Distribution

With respect to a powder, the particle size distribution measurement was carried out by a laser diffraction scattering method using a laser scattering particle size distribution measurement apparatus (Master sizer MS 2000, manufactured by Malvern Corp.) to measure D50 and the particle size distribution.

### 3. Measurement of Na Content in Powder for a Positive Electrode Active Material

After a powder was dissolved in hydrochloric acid, measurement was carried out by an inductively coupled plasma spectroscopic method (SPS 3000).

### 4. Production of Testing Battery for Charging/Discharging Test

A positive electrode active material, acetylene black as a conductive material, and PVdF (polyvinylidene fluoride) as a binder were weighed at a ratio of positive electrode active material:binder=86:10:4 (weight ratio) and the binder was dissolved in N-methylpyrrolidone (NMP) and the positive electrode active material and acetylene black was added further to obtain a paste and the paste was applied to a stainless steel mesh to be a current collector and the resulting stainless steel mesh was put in a vacuum drier and vacuum drying was carried out at 150° C. for 8 hours while removing NMP to obtain a positive electrode.

The obtained positive electrode, a solution obtained by dissolving LiPF6 to be 1 mol/L in a mixed solution of ethylene carbonate and ethyl methyl carbonate at 50:50 (volume ratio) as an electrolyte solution, a polypropylene porous membrane as a separator, and metal lithium as a negative electrode were assembled to produce a lithium secondary battery. The assembly of the lithium secondary battery was carried out in a globe box in argon atmosphere.

### Example 1

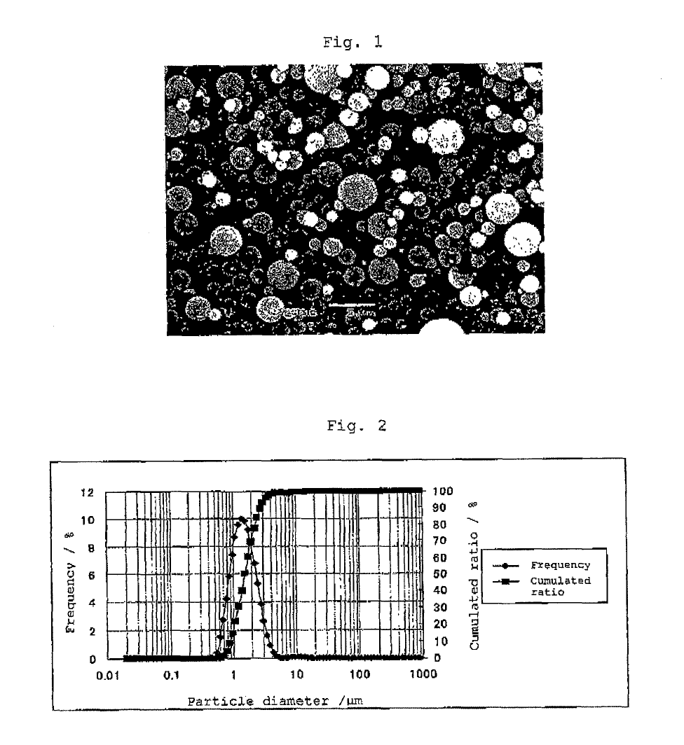

An aqueous solution obtained by dissolving 0.06 mol of nickel acetate and 0.06 mol of manganese acetate in 250 ml was used as a water phase, 600 ml of cyclohexane was used as an oil phase and fine pores of an SPG with an average fine pore diameter of 1 μm as fine pores were used and the water phase was passed through the fine pores and brought into contact with the oil phase to produce an emulsion. Specifically, as the SPG, a tube with an outer diameter of 1 cm, an inner diameter of 0.8 cm, a length of 10 cm, and a thickness of 1 mm was used and the water phase was set in the outside of the tube and the oil phase was set in the inside of the tube and the water phase was extruded to the inside of the tube through the SPG and brought into contact with the oil phase to produce an emulsion. At that time, both ends of the tube were bonded to a stainless steel pipe to circulate the oil phase by a pump (see FIG. 7). Further, extrusion of the water phase was carried out by applying pressure by supplying air at about 0.1 MPa pressure to the water phase. The SPG used was previously treated for oleophilic surface treatment by immersing it in an absolute toluene solution of trimethylchlorosilane. The oil phase used was obtained by previously adding a surfactant Span 20 (trade name, sorbitan monolaurate) in an amount of 1% by weight in cyclohexane. Next, the produce emulsion was recovered and gelation was carried out. As a gelling agent was used 0.6 mol of sodium carbonate and an aqueous solution obtained by dissolving it in 300 mL of pure water was dispersed in cyclohexane by a homogenizer to make the gelling agent in emulsion state and the gelling agent was added to the emulsion produced in the above-mentioned manner to carry out gelation and thereafter, the resulting emulsion was separated into a cake and a liquid by filtration and the cake was dried at 60° C. and pulverized by an agate mortar to obtain a powder for a positive electrode active material 1 which was subjected to SEM observation (result is shown in FIG. 1) and particle size distribution measurement by a laser diffraction scattering method (result is shown in FIG. 2). According to FIG. 1, it was found that the shape of the particles composing the powder was approximately spherical, and also according to FIG. 2, it was found that D50 was 1.5 μm and 95% by volume or more of particles existed in the range of 0.45 μm or larger and 4.5 μm or smaller. Further, similarly, according to FIG. 2, 95% by volume or more of particles existed in the range of 0.6 μm or larger and 6.0 μm or smaller. Further, the measurement of Na content in the powder for the positive electrode active material 1 was carried out to find that Na content in the powder for a positive electrode active material was 2% by weight.

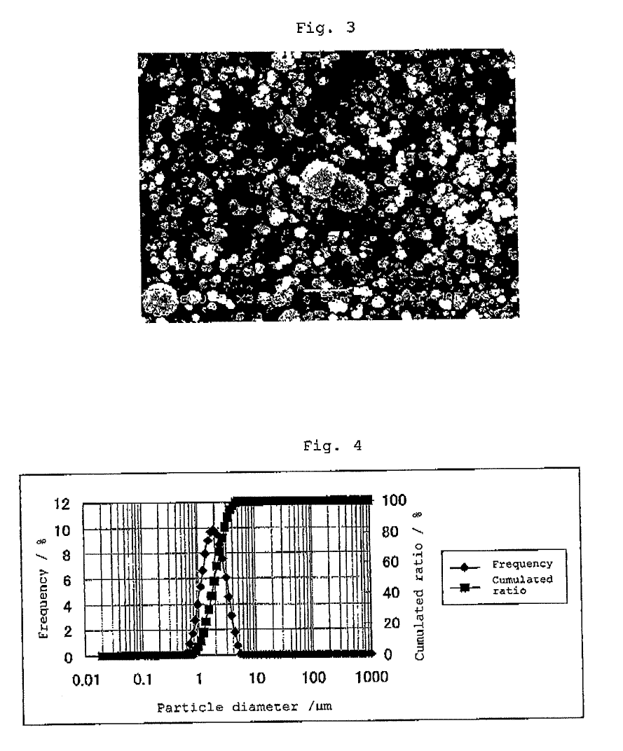

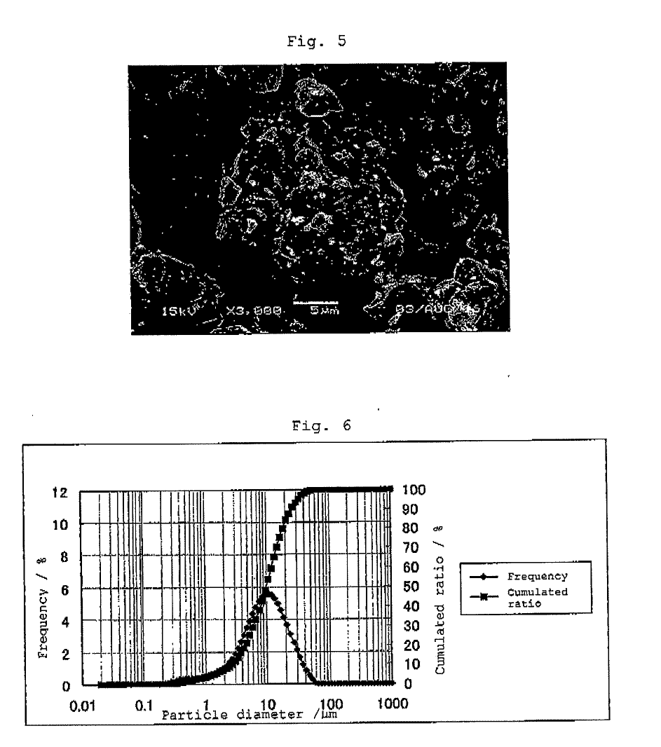

The above-mentioned powder for a positive electrode active material 1 and Li₂CO₃ were mixed in a mortar to obtain a mixture which was calcined at 1000° C. for 6 hours in air and pulverized in an agate mortar to obtain a powder state positive electrode active material 1. In the positive electrode active material, the mole ratio of Li:Ni:Mn was 1.04:0.48:0.48. With respect to the positive electrode active material 1, SEM observation (result is shown in FIG. 3) and particle size distribution measurement by a laser diffraction scattering method (result is shown in FIG. 4) were carried out. According to FIG. 4, D50 was found 2 μm and 95% by volume or more of particles existed in the range of 0.6 μm or larger and 6.0 μm or smaller.

### Example 2

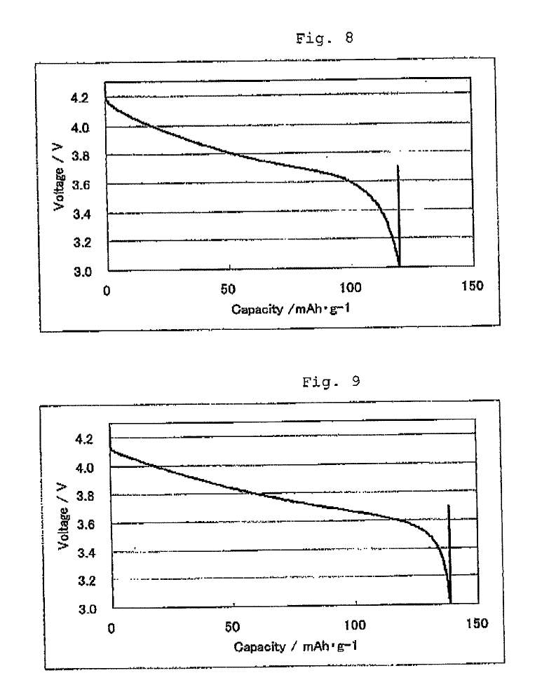

A lithium secondary battery was produced as described above using the positive electrode active material 1. With respect to the lithium secondary battery, charging/discharging evaluation was carried out in conditions of voltage range of 4.3 to 3.0 V and 0.2 C rate and as a result, the discharge capacity at the initial time was 120 mAh/g (result is shown in FIG. 8).

### Example 3

After 20 g of the powder for a positive electrode active material 1 was dispersed in 600 mL of ethanol, washing and filtration were carried out, and the power was further dispersed in 1 L of pure water and washing and filtration were carried out. The cake obtained by the filtration was vacuum dried at 60° C. for 8 hours to obtain a powder for a positive electrode active material 2. The particle size distribution of the powder for a positive electrode active material 2 was the same as that of the powder for a positive electrode active material 1 and D50 was 1.5 μm and 95% by volume or more of particles existed in the range of 0.45 μm or larger and 4.5 μm or smaller and 95% by volume or more of particles existed in the range of 0.6 μm or larger and 6.0 μm or smaller. Further, the Na content in the powder for the positive electrode active material 2 was 0.8% by weight. A positive electrode active material 2 was obtained using the powder for a positive electrode active material in the same manner as Example 1. The particle size distribution of the positive electrode active material 2 was the same as that of positive electrode active material 1.

### Example 4

A lithium secondary battery was produced as described above using the positive electrode active material 2. With respect to the lithium secondary battery, charging/discharging evaluation was carried out in conditions of voltage range of 4.3 to 3.0 V and 0.2 C rate and as a result, the discharge capacity at the initial time was 143 mAh/g (result is shown in FIG. 9).

### Comparative Example 1

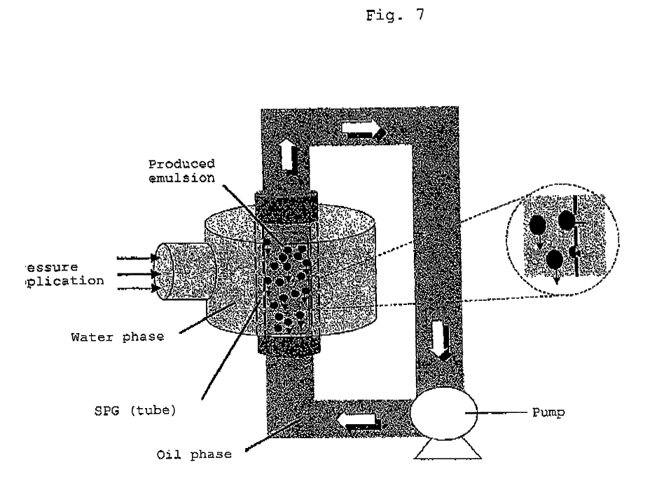

A powder for a positive electrode active material was obtained in the same manner as Example 1, except that an aqueous solution obtained by dissolving 0.12 mol of nickel hydroxide in 250 ml of pure water was used as a water phase. The powder, LiNO₃, and MnCl₂ were mixed in a mortar to obtain a mixture which was calcined at 100° C. for 6 hours in air to obtain a positive electrode active material 3. The positive electrode active material 3 could not be pulverized by an agate mortar. In the positive electrode active material, the mole ratio of Li:Ni:Mn was 1.04:0.48:0.48. With respect to the positive electrode active material 3, SEM observation (result is shown in FIG. 5) and particle size distribution measurement by a laser diffraction scattering method (result is shown in FIG. 4) were carried out. According to FIG. 6, D50 was found 9.8 μm and 95% by volume or more of particles existed in the range of 0.1 μm or larger and 70 μm or smaller and 80% by volume or more particles existed in the range of 2.9 μm or larger and 29 μm or smaller.

Accordingly, it could be understood that having particles with even particle diameter, a positive electrode active material obtained by using a powder for a positive electrode active material of the present invention could be filled more densely when it is used for a positive electrode of a nonaqueous electrolyte secondary battery, furthermore, the thickness of the positive electrode obtained was more even, and the discharge capacity of the nonaqueous electrolyte secondary battery obtained could be increased.

### Production Example

### Production of Laminated Porous Film

### (1) Production of Coating Solution for Heat Resistant Layer

After 272.7 g of calcium chloride was dissolved in 4200 g of N-methyl-2-pyrrolidone (NMP), 132.9 g of p-phenylenediamine was added and completely dissolved. The obtained solution was gradually mixed with 243.3 g of terephthalic acid dichloride and polymerization was carried out to obtain para-amide which was further diluted with NMP to obtain a para-amide solution with a concentration of 2.0% by weight. As filler, 2 g of a first alumina powder (Alumina C, average particle diameter 0.02 μm, manufactured by Nippon Aerosil) and 2 g of a second alumina powder (Sumicorandom AA03, manufactured by Sumitomo Chemical Co., Ltd., average particle diameter 0.3 μm) in total 4 g was added to 100 g of the obtained para-amide solution and treated three times by a nanomizer and further the resulting mixture was filtered by a metal net of 1000 mesh and defoamed in reduced pressure to produce a slurry-form coating solution for heat resistant layer. The weight of alumina powders (filler) to the total weight of the para-amide and the alumina powders was 67% by weight.

### (2) Production and Evaluation of Laminated Porous Film

As a shutting down layer, a porous membrane made of polyethylene (thickness 12 μm, air permeability 140 second/100 cc, average particle diameter 0.1 μm, and porosity 50%) was used. The above-mentioned porous membrane made of polyethylene was fixed on a PET film with a thickness of 100 μm and the slurry-form coating solution for a heat resistant layer was applied to the porous membrane by a bar coater manufactured by Tester Sangyo Co., Ltd. While the porous membrane applied to the PET film was kept in the united state, the film was immersed in water, which was a poor solvent to precipitate the para-amide porous film (heat resistant layer) and thereafter, the solvent was dried out and the PET film was separated to obtain a laminated porous film made of the heat resistant layer and the shutting down layer. The thickness of the laminated porous film was 16 μm and the thickness of the para-amide porous film (heat resistant layer) was 4 μm. The air permeability of the laminated porous film was 180 second/100 cc and the porosity was 50%. A cross-section of the heat resistant layer of the laminated porous film was observed by a scanning electronic microscope (SEM) to find that the layer had relatively small fine pores of about 0.03 μm to 0.06 μm and relatively large fine pores of about 0.1 μm to 1 μm. The laminated porous film was evaluated according to the following (A) to (C).

### (A) Thickness Measurement

The thickness of the laminated porous film and the thickness of the shutting down layer were measured according to JIS standard (K7130-1992). Further, the thickness of the heat resistant layer was defined as the value calculated by subtracting the thickness of the shutting down layer from the thickness of the laminated porous film.

### (B) Measurement of Air Permeability by Gurley Method

The air permeability of the laminated porous film was measured by a digital timer type Gurley Densometer manufactured by Yasuda Seiki Seisakusho according to JIS P8117.

### (C) Porosity

A sample of the obtained laminated porous film was cut in a 10 cm square and the weight W (g) and the thickness D (cm) were measured. The weight (Wi) of each layer in the sample was found and the volume of each layer was found from Wi and the true specific gravity (g/cm³) of the material for each layer and thus the air porosity (% by volume) was found according o the following expression.

Porosity(% by volume)=100×{1−(W1/true specific gravity 1+W2/true specific gravity 2+−+Wn/true specific gravity n)/(10×10×D)}

In the respective Examples described above, when the laminated porous film obtained in Production Example is used as a separator, nonaqueous electrolyte secondary batteries capable of prevention heat membrane breakage can be obtained.

1. A powder for a positive electrode active material comprising particles containing two or more elements selected from transition metal elements,
wherein, in the cumulative particle size distribution on the basis of volume of the particles composing the powder, a particle diameter (D50) observed from the finer particle side at 50% accumulation is in the range of 0.1 μm or larger and 10 μm or smaller, and 95% by volume or more of the particles composing the powder exist in the range of 0.3 time or more and 3 times or less as large as D50.

2. A powder for a positive electrode active material comprising particles containing two or more elements selected from transition metal elements,
wherein, 95% by volume or more of the particles composing the powder exist in the range of 0.6 μm or larger and 6 μm or smaller.

3. The powder for a positive electrode active material according to claim 1 containing at least Ni as a transition metal element

4. The powder for a positive electrode active material according to claim 1 containing two or more elements selected from Ni, Mn, Co and Fe as a transition metal element.

5. The powder for a positive electrode active material according claim 1, wherein the constituent particles composing the powder for a positive electrode active material are approximately spherical particles.

6. The powder for a positive electrode active material according to claim 1, wherein a content of Na in the powder for a positive electrode active material is 1% by weight or less.

7. A powder-form positive electrode active material obtained by calcining a mixture obtained by mixing the powder for a positive electrode active material according to claim 1 and a lithium compound.

8. The positive electrode active material according to claim 7,
wherein, in the cumulative particle size distribution on the basis of volume of the particles composing the positive electrode active material, the particle diameter (D50) observed from the finer particle side at 50% accumulation is in the range of 0.1 μm or larger and 10 μm or smaller, and 95% by volume or more of the particles composing the positive electrode active material exist in the range of 0.3 times or more and 3 times or less as large as D50.

9. A positive electrode active material according to claim 7, wherein the 95% by volume or more of the particles composing the positive electrode active material exist in the range of 0.6 μm or larger and 6 μm or smaller.

10. A method for producing the powder for a positive electrode active material comprising the following steps (1), (2), and (3) carried out in this order:
(1) a step of producing an emulsion by passing a water phase containing two or more elements selected from transition metal elements through fine pores with an average fine pore diameter of 0.1 to 15 μm and bringing the water phase into contact with an oil phase;
(2) a step of producing gel by bringing the emulsion into contact with a water-soluble gelling agent; and
(3) a step of separating the gel into a cake and a liquid and drying the cake to obtain a powder for a positive electrode active material.

11. A method for producing a positive electrode active material by mixing the powder for a positive electrode active material comprising particles containing two or more elements selected from transition metal elements,
wherein, in the cumulative particle size distribution on the basis of volume of the particles composing the powder, a particle diameter (D50) observed from the finer particle side at 50% accumulation is in the range of 0.1 μm or larger and 10 μm or smaller, and 95% by volume or more of the particles composing the powder exist in the range of 0.3 time or more and 3 times or less as large as D50 or the powder for a positive electrode active material obtained by the production method according to claim 10 with a lithium compound, and calcining the obtained mixture at a temperature of 600° C. or higher and 1100° C. or lower.

12. A positive electrode for a nonaqueous electrolyte secondary battery containing the positive electrode active material according to claim 7.

13. A nonaqueous electrolyte secondary battery comprising the positive electrode for a nonaqueous electrolyte secondary battery according to claim 12.

14. The nonaqueous electrolyte secondary battery according to claim 13 further comprising a separator.

15. The nonaqueous electrolyte secondary battery according to claim 14, wherein the separator comprises a laminated porous film formed by laminating a heat resistant layer containing a heat resistant resin and a shutting down layer containing a thermoplastic resin.
